(19) United States
(12) Patent Application Publication
(10) Pub. No.: US 2008/0090009 A1
(43) Pub. Date: Apr. 17, 2008

(54) METHOD FOR MANUFACTURING A MULTICOLOR ANTIQUE WOOD FLOORING

(76) Inventor: Jianguo XU, Huichun City (CN)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/951,267

(22) Filed: Dec. 5, 2007

Related U.S. Application Data
(63) Continuation of application No. PCT/CN2006/002126, filed on Aug. 21, 2006.

(30) Foreign Application Priority Data
Aug. 14, 2006 (CN) CN200610109385.0

(51) Int. Cl. B05D 1/36; B05D 5/00; B05D 3/00

(52) U.S. Cl. 427/258; 427/402; 427/262; 427/274

(57) ABSTRACT

The present invention discloses a method for manufacturing a flooring, in particular, to a method for manufacturing a multicolor antique wood flooring having an antique look and an embossed effect. It comprises the following steps: processing the raw material of the wood flooring to form an unvarnished flooring having the natural colors of lumber, and then performing water-based coloring with a dark color to the unvarnished flooring; drying; polishing; performing water-based coloring with a light color to the polished flooring; drying; applying a primer; drying; polishing; applying a top coat; and drying. Since coloring is performed for times in sequence in the manufacturing process, and the shades of the colors differ, and polishing are also performed for times, the places having different hardness in the wood grain present unevenness, and thus the wood flooring manufactured in this method has the advantages of having an embossed effect, many colors, different shades, irregular variations, and a strong sense of layers, as well as a prominent antique look and etc. and meanwhile, the level of the flooring is improved, which can cover the defects of low-quality flooring, and it is simple in processing, because the process of soaking coloring to the lumber in the manufacturing of conventional flooring is omitted.

### PRIORITY CLAIM

This application is a continuation of and incorporates by reference PCT/CN2006/002126 filed Aug. 21, 2006, which claims priority to CN200610109385.0 filed Aug. 14, 2006, which is also incorporated by reference.

### TECHNICAL FIELD

The present invention relates to a method for manufacturing a flooring, in particular, to a method for manufacturing a multicolor antique wood flooring having an antique look and an embossed effect.

### BACKGROUND OF THE INVENTION

Flooring is an indispensable ingredient for interior decoration, especially wood flooring. Due to its natural material, cold insulation function, and its easily processed and handy nature, it has become a customer favorite in decoration material. Currently, the method for manufacturing a conventional wood flooring is: firstly processing the raw material of the wood flooring to form the unvarnished flooring in strips or blocks of the desired specifications and having the natural colors of lumber, then performing the process of coloring, paint applying and polishing in the following steps: firstly performing water-based coloring to the unvarnished flooring, wherein the color is determined according to the needs; then performing drying, applying the primer, drying, polishing, applying the top coat, and drying. Wood flooring processed in the current processing method has a smooth surface, monotonous color and does not have an embossed effect, and thus a multicolor antique wood flooring cannot be manufactured in such a method.

### SUMMARY OF THE INVENTION

It is an object of the present invention to provide a method for manufacturing a multicolor antique wood flooring having an embossed effect.

The method for manufacturing a multicolor antique wood flooring of the present invention comprises the following steps:

a. processing the raw material of the wood flooring to form an unvarnished flooring having the natural colors of lumber, and then performing water-based coloring with a dark color to the unvarnished flooring;

b. drying;

c. polishing;

d. performing water-based coloring with a light color to the polished flooring;

e. drying;

f. applying a primer;

g. drying;

h. polishing;

i. applying a top coat; and

j. drying.

The method for manufacturing a multicolor antique wood flooring of the present invention, wherein the steps of applying a primer, drying, polishing, applying a primer and drying are performed in sequence to the flooring between the polishing in said step h and applying a top coat in said step i.

The method for manufacturing a multicolor antique wood flooring of the present invention, wherein the drying in said step b and the drying in step e are infrared drying, and the drying in said step g and the drying in step j are UV light drying, and the polishing in said step h is DuPont threads polishing. The drying in the steps of applying a primer, drying, polishing, applying a primer and drying performed in sequence to the flooring between the polishing in said step h and applying a top coat in the step i are UV light drying and the polishing in the steps is DuPont threads polishing.

The method for manufacturing a multicolor antique wood flooring of the present invention, wherein the dark color is black walnut, or brown, or coffee, or earth tones or etc. and said light color is ginger, or cherry, or wheat, or rose or etc.

The method for manufacturing a multicolor antique wood flooring of the present invention, wherein polishing is performed to the flooring between the drying in step e and applying a primer in step f.

The method for manufacturing a multicolor antique wood flooring of the present invention, wherein the steps of polishing, oil-based coloring, drying and polishing are performed in sequence to the flooring between the drying in said step e and applying a primer in the step f, and said oil-based coloring is adding oily pigment into the primer to color the flooring, and said drying is UV light drying and said polishing is DuPont threads polishing.

The method for manufacturing a multicolor antique wood flooring of the present invention, since coloring is performed for times in sequence in the manufacturing process, and the shades of the colors differ, and polishing are also performed for times, the places having different hardness in the wood grain present unevenness, and thus the wood flooring manufactured in this method has the advantages of having an embossed effect, many colors, different shades, irregular variations, and a strong sense of layers, as well as a prominent antique look and etc. and meanwhile, the level of the flooring is improved, which can cover the defects of low-quality flooring, and it is simple in processing, because the process of soaking coloring to the lumber in the manufacturing of conventional flooring is omitted.

### DESCRIPTION OF THE PREFERRED EMBODIMENTS

Firstly, the raw material of the wood flooring is processed to form the unvarnished flooring having the natural colors of lumber, wherein its processing refers to the processing of lumber in which the required specifications and shapes are met, and said unvarnished flooring refers to a semi-finished product of flooring not dyed in any color or paint and which is formed by the processing of lumber alone, and the above is prior art and thus is not depicted here in detail.

The water-based coloring with a dark color to the unvarnished flooring is performed, said dark color adopts black walnut, or it may adopt brown, or coffee, or earth tones, or etc., and said colors are conventional colors used in the manufacturing of conventional floorings. Water-based coloring indicates that the pigment used is water soluble.

After water-based coloring with a dark color, drying is performed, and infrared drying devices are adopted for drying, wherein the drying temperature may be set at 97°, or 98°, or 99°, or 100°, or 101°, or 102° or 103° C., and the drying period may be set at 28 seconds, or 29 seconds, or 30 seconds, or 31 seconds or 32 seconds.

After the aforesaid drying, polishing is performed, and it is performed by a conventional cylindrical abrasive belt wheel polishing machine.

Water-based coloring with a light color is performed to the flooring after polishing, said light color adopts ginger, or it may adopt cherry, or wheat, or rose, said colors are also conventional colors used in the manufacturing of conventional floorings. Water-based coloring still indicates that the pigment used is water soluble.

After water-based coloring with a light color, drying is performed, and infrared drying devices are adopted for drying, wherein the drying temperature may be set at 97°, or 98°, or 99°, or 100°, or 101°, or 102° or 103° C., and the drying period may be set at 28 seconds, or 29 seconds, or 30 seconds, or 31 seconds or 32 seconds.

after the flooring is dried, a primer is applied in a roller painting manner and drying is performed. and said drying is performed using a UV light, and then polishing is performed, wherein said polishing is performed by DuPont threads polishing machine, and a top coat is applied to the flooring after DuPont threads polishing, and then drying is performed, wherein the drying is also performed using a UV light. A bicolor antique wood flooring having an embossed effect can be manufactured through the steps of the aforesaid process.

To achieve a better effect, the steps of applying a primer, drying, polishing, applying a primer and drying can be performed in sequence to the flooring after the DuPont threads polishing and before applying a top coat, wherein the drying is UV light drying, and the polishing is DuPont threads polishing.

In order to obtain a tricolor flooring, the flooring is polished before applying a primer for the first time in the aforesaid process, wherein said polishing is performed to the flooring by a conventional cylindrical abrasive belt wheel polishing machine such that the flooring presents colors of wood, together with the second time coloring, a flooring having three colors and different layers can be manufactured.

Another method for manufacturing a tricolor flooring is performing polishing, oil-based coloring, drying and re-polishing to the flooring in sequence before applying a primer for the first time in the aforesaid process, wherein said polishing is performed by a conventional cylindrical abrasive belt wheel polishing machine, and said oil-based coloring is mixing the predetermined oily pigment into the primer and stirring for coloring, said drying is UV light drying, and said re-polishing is DuPont threads polishing. An antique flooring having three colors and different layers can be manufactured in the aforesaid method.

### INDUSTRIAL APPLICABILITY

The method for manufacturing a multicolor antique wood flooring of the present invention is used for manufacturing indoor wood flooring, and the flooring manufactured in this method has many colors, an embossed effect and an antique look.

1. A method for manufacturing a multicolor antique wood flooring, characterized in that it comprises the following steps:
a. processing the raw material of the wood flooring to form an unvarnished flooring having the natural colors of lumber, and then performing water-based coloring with a dark color to the unvarnished flooring;
b. drying;
c. polishing;
d. performing water-based coloring with a light color to the polished flooring;
e. drying;
f. applying a primer;
g. drying;
h. polishing;
i. applying a top coat; and
j. drying.

2. The method for manufacturing a multicolor antique wood flooring of claim 1, characterized in:
the steps of applying a primer, drying, polishing, applying a primer and drying are performed in sequence to the flooring between the polishing in said step h and applying a top coat in step i.

3. The method for manufacturing a multicolor antique wood flooring of claim 2, characterized in:
the drying in said step b and the drying in step e are infrared drying, and the drying in said step g and the drying in step j are UV light drying, and the polishing in said step h is DuPont threads polishing, the drying in the steps of applying a primer, drying, polishing, applying a primer and drying performed in sequence to the flooring between the polishing in said step h and applying a top coat in the step i are UV light drying and the polishing in the steps is DuPont threads polishing.

4. The method for manufacturing a multicolor antique wood flooring of claim 3, characterized in:
the dark color is black walnut, or brown, or coffee, or earth tones or etc. and said light color is ginger, or cherry, or wheat, or rose or etc.

5. The method for manufacturing a multicolor antique wood flooring of claim 3, characterized in:
polishing is performed to the flooring between drying in step e and applying a primer in step f, and the tool for said polishing is a conventional cylindrical abrasive belt wheel polishing machine.

6. The method for manufacturing a multicolor antique wood flooring of claim 4, characterized in:
polishing is performed to the flooring between drying in step e and applying a primer in step f, and the tool for said polishing is a conventional cylindrical abrasive belt wheel polishing machine.

7. The method for manufacturing a multicolor antique wood flooring of claim 1, characterized in:
the steps of polishing, oil-based coloring, drying and polishing are performed in sequence to the flooring between the drying in said step e and applying a primer in the step f, and said oil-based coloring is adding oily pigment into the primer to color the flooring, and said drying is UV light drying and said polishing is DuPont threads polishing.

8. The method for manufacturing a multicolor antique wood flooring of claim 2, characterized in:
the steps of polishing, oil-based coloring, drying and polishing are performed in sequence to the flooring between the drying in said step e and applying a primer in the step f, and said oil-based coloring is adding oily pigment into the primer to color the flooring, and said drying is UV light drying and said polishing is DuPont threads polishing.

9. The method for manufacturing a multicolor antique wood flooring of claim 3, characterized in:
the steps of polishing, oil-based coloring, drying and polishing are performed in sequence to the flooring between the drying in said step e and applying a primer in the step f, and said oil-based coloring is adding oily pigment into the primer to color the flooring, and said drying is UV light drying and said polishing is DuPont threads polishing.

10. The method for manufacturing a multicolor antique wood flooring of claim 4, characterized in:
the steps of polishing, oil-based coloring, drying and polishing are performed in sequence to the flooring between the drying in said step e and applying a primer in the step f, and said oil-based coloring is adding oily pigment into the primer to color the flooring, and said drying is UV light drying and said polishing is DuPont threads polishing.
